(19) United States
(12) Patent Application Publication
(10) Pub. No.: US 2014/0244424 A1
(43) Pub. Date: Aug. 28, 2014

(54) DYNAMIC VEHICLE PRICING SYSTEM, METHOD AND COMPUTER PROGRAM PRODUCT THEREFOR

(71) Applicant: TrueCar, Inc., Santa Monica, CA (US)

(72) Inventors: Michael D. Swinson, Santa Monica, CA (US); Xingchu Liu, Austin, TX (US)

(73) Assignee: TrueCar, Inc., Santa Monica, CA (US)

(21) Appl. No.: 14/054,390

(22) Filed: Oct. 15, 2013

Related U.S. Application Data
(60) Provisional application No. 61/770,654, filed on Feb. 28, 2013.

(51) Int. Cl. G06Q 30/06; G06Q 30/02

(52) U.S. Cl. CPC G06Q 30/0621; G06Q 30/0283
USPC 705/26.5

(57) ABSTRACT

Embodiments provide consumers browsing and shopping online for durable goods such as new vehicles with pricing information for user-specified vehicle configurations based at least in part on dynamic, user-centric local regions that can be any shape. A local region may initially center around or start from user-provided geo-specific information and be refined using criteria such as distance, demographics, buying behaviors, etc. The system can leverage data from the finest level of granularity available and dynamically determine multiple, potentially overlapping, local regions which can be user-specific, product-specific, or both. A pricing model may incorporate the data within a dynamic local region thus determined. The parameters of the pricing model may be weighted utilizing a weighting function that can be dynamically adapted to individual users as well as specific vehicles. The pricing model may provide for pricing information that is not limited or constrained by standard administrative or political boundaries.

### CROSS-REFERENCE TO RELATED APPLICATION(S)

This is a conversion of, and claims a benefit of priority from U.S. Provisional Application No. 61/770,654, filed Feb. 28, 2013, entitled, “DYNAMIC VEHICLE PRICING SYSTEM, METHOD AND COMPUTER PROGRAM PRODUCT THEREFOR,” which is fully incorporated herein by reference.

### COPYRIGHT NOTICE

A portion of the disclosure of this patent document contains material to which a claim for copyright is made. The copyright owner has no objection to the facsimile reproduction by anyone of the patent document or the patent disclosure, as it appears in the Patent and Trademark Office patent file or records, but reserves all other copyright rights whatsoever.

### TECHNICAL FIELD

This disclosure relates generally to pricing products in a marketplace. More particularly, embodiments disclosed herein relate to a user-centric, adaptive dynamic vehicle pricing system, method, and computer program product.

### BACKGROUND OF THE RELATED ART

When purchasing a high value item such as a vehicle, consumers are often faced with the problem in finding and/or understanding what the true value for that item might be. For example, today's vehicle marketplace offers a multitude of methods for pricing vehicles. Unfortunately, these methods often report inconsistent or even conflicting prices for vehicles. Furthermore, conventional methods for vehicle pricing are generally based on administrative boundaries, such as countries, U.S. Census regions, and states. Consumers searching for a vehicle in geographic areas smaller than U.S. Census regions may face additional challenges as pricing data in such areas tend to be sparse, resulting in vehicle prices for the same model and trim vary greatly from area to area.

Complicating the matter is the fact that consumers often do not have sufficient, relevant, and/or accurate information on a particular vehicle or does not understand such information, including interdependence between local demand and availability of the vehicle. To illustrate with a specific example, a recommended price (e.g., $20,000) for a particular vehicle model and trim may not take into account how sensitive that price is (“Is $19,000 a good or bad price for this vehicle model and trim in a beach town on an island?”) or how the vehicle model compares to another vehicle model with a similar trim at about the same price.

### SUMMARY OF THE DISCLOSURE

Embodiments disclosed herein provide a system, method, and computer program product implementing a pricing model that can, in response to a user inquiry, dynamically generate and present local product pricing information tailored to user-specified information such as a specific vehicle configuration and/or locale. For the purpose of illustration and not of limitation, vehicles are used in this disclosure to exemplify products on which a user may wish to obtain pricing information. Those skilled in the art can appreciate that the pricing model disclosed herein can be implemented to provide dynamic local pricing information on other types of products.

Such a user inquiry may be received by a vehicle data system through a network site. In some embodiments, the vehicle data system may interact with a visitor of the network site in a frontend, real-time or “online” process. The user-specified information received by the vehicle data system may include vehicle specific information such as the year, make, model, body, and trim of one or more vehicles and may also include geo-specific information such as a zip code and/or a street address.

In some embodiments, the vehicle data system may compute industry-specific market areas, vehicle-specific market areas, or a combination thereof, in a backend, “offline” process, persist the results (for instance, in one or more lookup tables), and access the stored information in a frontend process to dynamically select an appropriate local region in response to a user inquiry.

In embodiments disclosed herein, the vehicle pricing information does not need to be limited to or confined by pre-defined geographic regions, standard administrative or political boundaries, or known marketing boundaries such as zip codes, Designated Market Areas (DMAs), sub-DMAs, etc. Rather, a local region can be defined, dynamically in some embodiments, based on one or more criteria. A local region can be any shape such as a circle or some randomly defined geographic boundary. Unlike predetermined or known boundaries, these dynamically determined local regions are not fixed and can overlap.

Initially, a local region may center around or start from a user-provided geo-specific information (also referred to herein as “user locale”). The local region may be refined, considering criteria such as distance, demographics, buying behaviors, etc. and leveraging data from the finest level of granularity available to the vehicle data system. Accordingly, local regions may be dynamically determined based on industry-specific data, non-industry-specific data, or a combination thereof.

In some embodiments, multiple, potentially overlapping, local regions can be dynamically defined and/or selected for the same user locale, each local region being defined and/or selected depending upon a criterion or criteria of interest. Since each local region may take various criteria into consideration, no two local regions may be identical even if they are defined from the same user locale. For example, a user may be interested in purchasing a Mercedes Benz E-Class sedan and a Ford F150 pickup truck. Local regions for these two different vehicles may be vastly different, although both may be drawn from the same user locale.

In some embodiments, a pricing model may incorporate some or all of the data within a local region that is dynamically defined or selected based on user-specified information. The parameters of the pricing model may be weighted utilizing a weighting function. The weights in the weighting function can be optimized in various ways. One example of weighting can be that all attributes are equally weighted. One example of weighting can be triangular shaped. Other weighting functions may also be used to combine geographic closeness. Further, weighting can be dynamically adapted to individual users as well as specific vehicles.

Embodiments disclosed herein can provide many advantages. For example, in some embodiments, the pricing model may provide for a vehicle estimation that is dynamic, user-centric, and adaptive to user-specified information and that is not limited or constrained by standard administrative or political boundaries. Utilizing dynamically determined local regions which can be user-specific, product-specific, or both, embodiments can compute, for each individual user, the best pricing for a desired vehicle configuration in real time or substantially real time.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions and/or rearrangements may be made within the scope of the disclosure without departing from the spirit thereof, and the disclosure includes all such substitutions, modifications, additions and/or rearrangements.

### BRIEF DESCRIPTION OF THE DRAWINGS

The drawings accompanying and forming part of this specification are included to depict certain aspects of the disclosure. It should be noted that the features illustrated in the drawings are not necessarily drawn to scale. A more complete understanding of the disclosure and the advantages thereof may be acquired by referring to the following description, taken in conjunction with the accompanying drawings in which like reference numbers indicate like features and wherein:

FIG. 1 depicts one embodiment of a topology including one example embodiment of a vehicle data system;

FIG. 2 depicts a flow diagram illustrating one example embodiment of a method for vehicle pricing using predetermined industry-specific market areas;

FIG. 3 depicts a diagrammatic representation of a map showing examples of predetermined industry-specific market areas;

FIG. 4 depicts a flow diagram illustrating one example embodiment of a method for vehicle pricing using predetermined vehicle-specific market areas;

FIG. 5 depicts a flow diagram illustrating one example embodiment of a method for vehicle pricing using dynamic market areas;

FIG. 6 depicts a flow diagram illustrating one example embodiment of a method for vehicle pricing using variable market areas;

FIG. 7 depicts a diagrammatic representation of a map showing predetermined market areas and dynamically determined local regions;

FIG. 8 depicts a diagrammatic representation of example “chunks” of geographic areas for fine-tuning a local region;

FIG. 9 depicts a flow diagram illustrating an example of a method for constructing a pricing model for providing user-centric, adaptive dynamic vehicle pricing based at least in part on variable market areas;

FIGS. 10A-10B depict diagrammatic representations of flexible variable local regions that may be dynamically determined for a user in response to the user requesting pricing information on a particular vehicle configuration; and

FIG. 11 depicts a diagrammatic representation of a screenshot of an example user interface showing local level pricing information on a user-specified vehicle with trim-level specificity.

### DETAILED DESCRIPTION

The invention and the various features and advantageous details thereof are explained more fully with reference to the non-limiting embodiments that are illustrated in the accompanying drawings and detailed in the following description. Descriptions of well-known processing techniques, components and equipment are omitted so as not to unnecessarily obscure the invention in detail. It should be understood, however, that the detailed description and the specific examples, while indicating preferred embodiments of the invention, are given by way of illustration only and not by way of limitation. Various substitutions, modifications, additions and/or rearrangements within the spirit and/or scope of the underlying inventive concept will become apparent to those skilled in the art from this disclosure. Embodiments discussed herein can be implemented in suitable computer-executable instructions that may reside on a computer readable medium (e.g., a hard disk (HD)), hardware circuitry or the like, or any combination.

Before discussing specific embodiments, a brief overview of the context of the disclosure may be helpful.

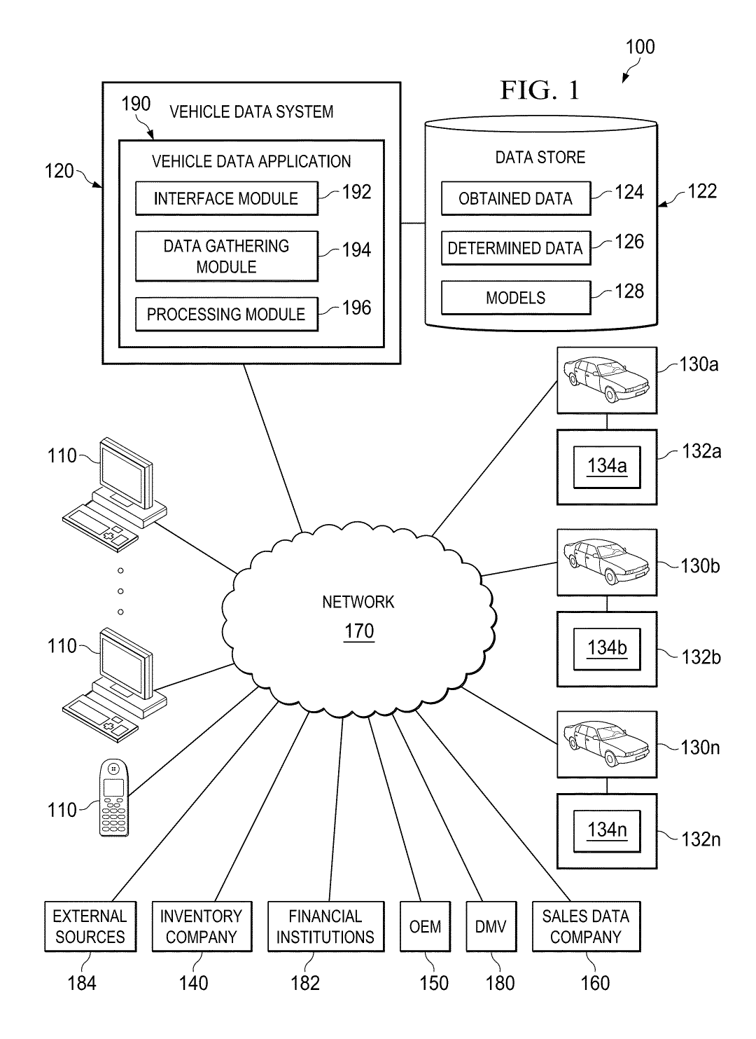

FIG. 1 depicts one embodiment of a topology which may be used to implement embodiments of the systems and methods disclosed herein. Topology 100 comprises a set of entities including vehicle data system 120 (also referred to herein as the TrueCar system) which is coupled through network 170 to computing devices 110 (e.g., computer systems, personal data assistants, kiosks, dedicated terminals, mobile telephones, smart phones, etc.), and one or more computing devices at inventory companies 140, original equipment manufacturers (OEM) 150, sales data companies 160, financial institutions 182, external information sources 184, departments of motor vehicles (DMV) 180 and one or more associated point of sale locations, in this embodiment, car dealers 130a . . . n. Computing devices 110 may be used by consumers while conducting a search for consumer goods and/or services, such as automobiles. Network 170 may be for example, a wireless or wired communication network such as the Internet or wide area network (WAN), publicly switched telephone network (PTSN) or any other type of electronic or non-electronic communication link such as mail, courier services or the like.

Vehicle data system 120 may comprise one or more computer systems with central processing units executing instructions embodied on one or more computer readable media where the instructions are configured to perform at least some of the functionality associated with embodiments disclosed herein. These applications may include a vehicle data application 190 comprising one or more applications (instructions embodied on one or more non-transitory computer readable media) configured to implement an interface module 192, data gathering module 194 and processing module 196 utilized by the vehicle data system 120. Furthermore, vehicle data system 120 may include data store 122 operable to store obtained data 124, data 126 determined during operation, models 128 which may comprise a set of dealer cost model or price ratio models, or any other type of data associated with embodiments disclosed herein or determined during the implementation of those embodiments.

Vehicle data system 120 may provide a wide degree of functionality, including utilizing one or more interfaces 192 configured to, for example, receive and respond to queries from users at computing devices 110; interface with inventory companies 140, manufacturers 150, sales data companies 160, financial institutions 182, DMVs 180 or dealers 130a . . . n to obtain data; or provide data obtained, or determined, by vehicle data system 120 to any of inventory companies 140, manufacturers 150, sales data companies 160, financial institutions 182, DMVs 180, external data sources 184 or dealers 130a . . . n. It will be understood that the particular interface 192 utilized in a given context may depend on the functionality being implemented by vehicle data system 120, the type of network 170 utilized to communicate with any particular entity, the type of data to be obtained or presented, the time interval at which data is obtained from the entities, the types of systems utilized at the various entities, etc. Thus, these interfaces may include, for example, web pages, web services, a data entry or database application to which data can be entered or otherwise accessed by an operator, or almost any other type of interface which it is desired to utilize in a particular context.

In general, then, using these interfaces 192 vehicle data system 120 may obtain data from a variety of sources, including one or more of inventory companies 140, manufacturers 150, sales data companies 160, financial institutions 182, DMVs 180, external data sources 184 or dealers 130a . . . n and store such data in data store 122. This data may be then grouped, analyzed or otherwise processed by vehicle data system 120 to determine desired data 126 or models 128 which are also stored in data store 122.

A user at computing device 110 may access the vehicle data system 120 through the provided interfaces 192 and specify certain parameters, such as a desired vehicle configuration or incentive data the user wishes to apply, if any. The vehicle data system 120 can select a particular set of data in the data store 122 based on the user specified parameters, process the set of data using processing module 196 and models 128, generate interfaces using interface module 192 using the selected data set on the computing devices 110 and data determined from the processing, and present these interfaces to the user at the user's computing device 110. Interfaces 192 may visually present the selected data set to the user in a highly intuitive and useful manner.

A visual interface may present at least a portion of the selected data set as a price curve, bar chart, histogram, etc. that reflects quantifiable prices or price ranges (e.g., “average,” “good,” “great,” “overpriced,” etc.) relative to reference pricing data points (e.g., invoice price, MSRP, dealer cost, market average, internet average, etc.). Using these types of visual presentations may enable a user to better understand the pricing data related to a specific vehicle configuration. Additionally, by presenting data corresponding to different vehicle configurations in a substantially identical manner, a user can easily make comparisons between pricing data associated with different vehicle configurations. To further aid the understanding for a user of the presented data, the interface may also present data related to incentives which were utilized to determine the presented data or how such incentives were applied to determine presented data.

Turning to the various other entities in topology 100, dealers 130a . . . n may include a retail outlet for consumer goods and/or services, such as vehicles manufactured by one or more of OEMs 150. To track or otherwise manage sales, finance, parts, service, inventory and back office administration needs, a dealer may employ a dealer management system (DMS) (e.g., DMS132a . . . n). Since many DMSs are Active Server Pages (ASP) based, transaction data (transaction data 134a . . . n) may be obtained directly from the DMS with a “key” (for example, an ID and Password with set permissions within the DMS system) that enables data to be retrieved from the DMS. Many dealers may also have one or more web sites which may be accessed over network 170, where pricing data pertinent to the dealers may be presented on those web sites, including any pre-determined, or upfront, pricing. This price is typically the “no haggle” price (i.e., price with no negotiation) and may be deemed a “fair” price by vehicle data system 120.

Inventory companies 140 may be one or more inventory polling companies, inventory management companies or listing aggregators which may obtain and store inventory data from one or more of dealers 130a . . . n (for example, obtaining such data from DMS 132a . . . n). Inventory polling companies are typically commissioned by the dealer to pull data from a DMS and format the data for use on websites and by other systems. Inventory management companies manually upload inventory information (photos, description, specifications) on behalf of the dealer. Listing aggregators get their data by “scraping” or “spidering” websites that display inventory content and receiving direct feeds from listing websites (for example, AutoTrader.com, FordVehicles.com, etc.).

DMVs 180 may collectively include any type of government entity to which a user provides data related to a vehicle. For example, when a user purchases a vehicle it must be registered with the state (for example, DMV, Secretary of State, etc.) for tax and titling purposes. This data typically includes vehicle attributes (for example, model year, make, model, mileage, etc.) and sales transaction prices for tax purposes.

Financial institution 182 may be any entity such as a bank, savings and loan, credit union, etc. that provides any type of financial services to a participant involved in the purchase of a vehicle. For example, when a buyer purchases a vehicle, they may utilize a loan from a financial institution, where the loan process usually requires two steps: applying for the loan and contracting the loan. These two steps may utilize vehicle and consumer information in order for the financial institution to properly assess and understand the risk profile of the loan. Typically, both the loan application and loan agreement include proposed and actual sales prices of the vehicle.

Sales data companies 160 may include any entities that collect any type of vehicle sales data. For example, syndicated sales data companies aggregate new and used sales transaction data from DMSs of particular dealers. These companies may have formal agreements with certain dealers that enable them to retrieve data from the dealers in order to syndicate the collected data for the purposes of internal analysis or external purchase of the data by other data companies, dealers, and OEMs.

Manufacturers 150 can be those entities which actually build the vehicles sold by dealers 130a . . . n. To guide the pricing of their vehicles, manufacturers 150 may provide an Invoice price and a Manufacturer's Suggested Retail Price (MSRP) for both vehicles and options for those vehicles—to be used as general guidelines for the dealer's cost and price. These fixed prices are set by the manufacturer and may vary slightly by geographic region.

External information sources 184 may comprise any number of other various source, online or otherwise, which may provide other types of desired data, for example data regarding vehicles, pricing, demographics, economic conditions, markets, locale(s), consumers, etc.

It should be noted here that not all of the various entities depicted in topology 100 are necessary, or even desired, in embodiments disclosed herein, and that certain of the functionality described with respect to the entities depicted in topology 100 may be combined into a single entity or eliminated altogether. Additionally, in some embodiments other data sources not shown in topology 100 may be utilized. Topology 100 is therefore exemplary only and should in no way be taken as imposing any limitations on embodiments disclosed herein.

As noted above, a user at a client device communicatively connected to an embodiment of a vehicle data system disclosed herein (e.g., vehicle data system 120) may have access to the vehicle data system via a visual interface running on the client device (e.g., an instance of interface 192 implemented as a web page of a browser application running on the client device). The user may specify a desired vehicle configuration and his location information (e.g., street address, city, state, zip code, or some combination thereof). The vehicle data system may present quantifiable vehicle prices or price ranges (e.g., “average,” “good,” “great,” “overpriced,” “fair,” etc.) for the desired vehicle configuration relative to the user-specified location information. Each of these prices reflects what the user can expect to pay for a vehicle having the desired vehicle configuration (“vehicle price”) at a dealership.

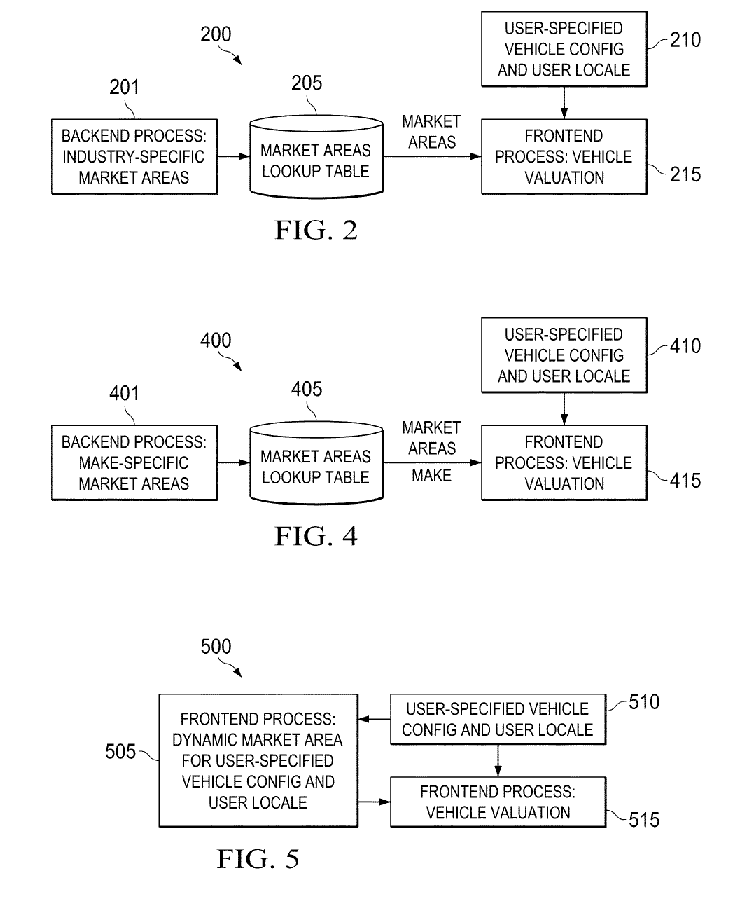

The vehicle data system may determine the vehicle prices/price ranges in many ways. For example, some embodiments of the vehicle data system may implement a vehicle pricing model that can aggregate data from various sources and transform the data into geo-specific vehicle prices. The data transformation may, in some embodiments, occur in an offline, backend process. The vehicle data system may integrate the backend data aggregation and transformation process with a frontend vehicle valuation process such that, in response to a user inquiry on a specific vehicle configuration, geo-specific vehicle prices appropriate for the user's location can be determined and presented (e.g., via interface 192) to the user. This is further illustrated in FIG. 2.

As illustrated in FIG. 2, in some embodiments, vehicle data system 200 may perform offline calculations and compute industry-specific market areas in backend process 201. Vehicle data system 200 may be an embodiment of vehicle data system 120 described above with reference to FIG. 1. These industry-specific market areas can be computed independently and are not specific to a user or a product. The industry-specific market areas can be persisted and stored in lookup table 205 for later use, for instance, by frontend vehicle valuation process 215. FIG. 3 depicts a diagrammatic representation of a map showing examples of predetermined industry-specific market areas. In response to user query 210, which can include a user-specified vehicle configuration and location, frontend process 215 may access lookup table 205 and select an appropriate industry-specific market area for geo-specific vehicle pricing.

Aspects, features, and examples of a geo-specific vehicle pricing methodology are provided in U.S. patent application Ser. No. 13/173,357, filed Jun. 30, 2011, entitled “SYSTEM, METHOD AND COMPUTER PROGRAM PRODUCT FOR GEO-SPECIFIC VEHICLE PRICING,” which is fully incorporated by reference herein. Aspects, features, and examples of a methodology for constructing spatially constrained industry-specific market areas are provided in U.S. patent application Ser. No. 14/026,111, filed Sep. 13, 2013, entitled “SYSTEM AND METHOD FOR CONSTRUCTING SPATIALLY CONSTRAINED INDUSTRY-SPECIFIC MARKET AREAS,” which is fully incorporated by reference herein.

Some embodiments of the vehicle data system may determine the vehicle prices/price ranges using predetermined vehicle-specific market areas. As illustrated in FIG. 4, in some embodiments, vehicle data system 400 may perform offline calculations and compute make-specific market areas in backend process 401. Vehicle data system 400 may be an embodiment of vehicle data system 120 described above with reference to FIG. 1. These make-specific market areas can be computed independently and persisted and stored in lookup table 405 for later use. The make-specific market areas thus computed are vehicle-specific but are not user-specific. For example, a market area for BMW 3-series could be larger or smaller than BMW 5-series regardless of a user locale. Further, in addition to the make level market areas calculation, additional market areas can be computed offline at other granularities such as the trim level. In response to user query 410, frontend process 415 may access lookup table 405 and select an appropriate vehicle-specific market area based on user-specified information such as a specific vehicle configuration and user locale.

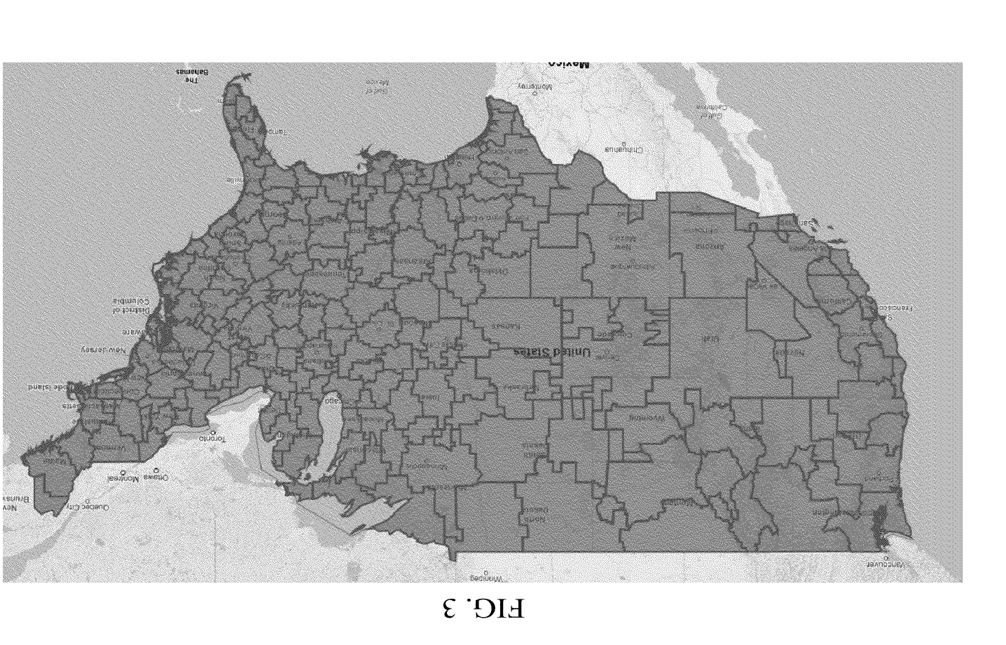

FIG. 5 depicts a flow diagram illustrating one example embodiment for vehicle pricing for dynamic market areas. In this scenario, it is not necessary to calculate all the market areas offline. Rather, a user-oriented or user-centric approach is employed. With the user-centric approach, trim-specific market areas can be dynamically generated. More specifically, user inputs can drive a frontend process in which a market area is dynamically defined utilizing the user-specified vehicle configuration and user locale. One example is illustrated in FIG. 7.

FIG. 7 depicts a diagrammatic representation illustrating one example embodiment for determining local regions based on user-specified vehicle configuration information, for instance, at the trim level. Suppose a user enters a specific trim and a street address. The user-specified street address (user locale) can be used by a front end process to dynamically generate a market area for the specific trim (“Local Region X”). The dynamically generated Local Region X can then be used in a dynamic vehicle valuation process to generate vehicle pricing data which can then be presented to the user. Suppose the user then enters another trim and the same street address. The user locale is again used by a front end process but this time a different market area is dynamically generated for the different trim (“Local Region Y”).

One advantage of this approach is that the dynamic computation only needs to consider data for the user-specified trim and does not need to exhaust all the possible trim combinations for a particular vehicle make. For example, demographics and buying behaviors for a given trim and zip code are considered in order to dynamically define a market area. However, demographics and buying behaviors for other possible trims of the same make need not be considered, since the user only specifies a particular trim. This can reduce the need for computational power.

The user locale can be used by a front end process to generate dynamic market areas at various levels of vehicle information. Because a dynamic market area thus defined is not fixed or limited to any particular size, geographic or political boundary, or DMA, another advantage is that it may better serve the interests and/or needs of the inquiring user. For example, a dealer may wish to obtain vehicle pricing information relative to other dealers in a certain local region where the dealer conducts its business. A dynamic market area defined based on a vehicle configuration and user locale provided by the dealer may more accurately reflect the dealer's customer base, as supposed to a fixed DMA or zip code. For example, Local Region X may represent a customer base for Toyota vehicles and Local Region Y may represent a customer based for Ford vehicles, even though the same user locale is used.

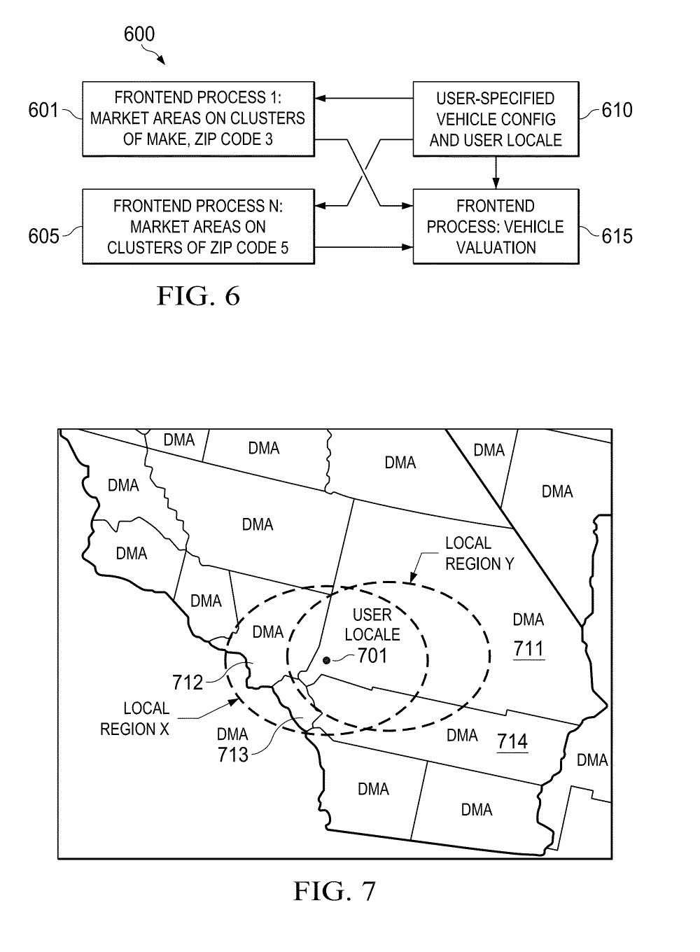

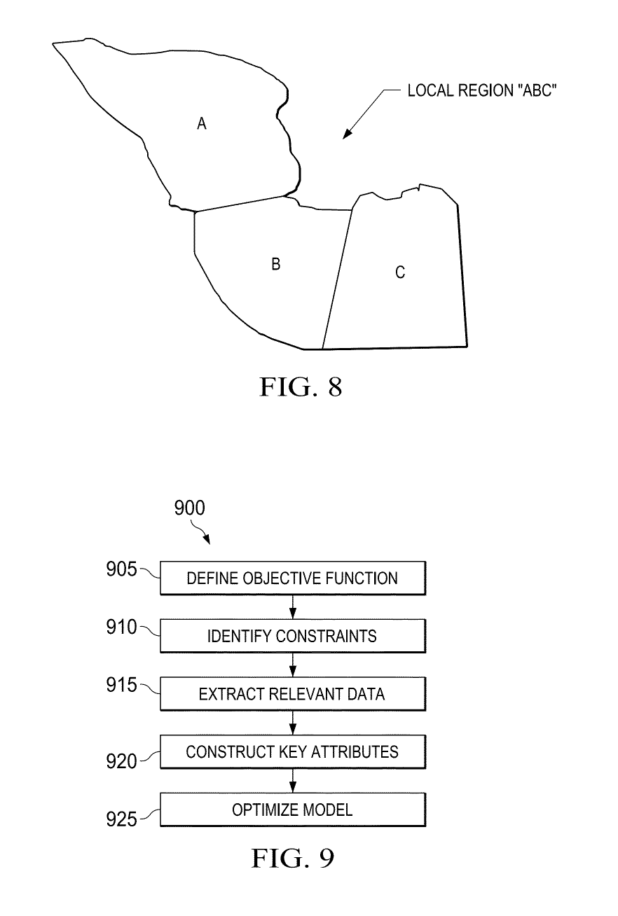

FIG. 6 depicts a flow diagram illustrating one example embodiment for vehicle pricing for variable market areas. In this scenario, different types and/or levels of information may exist within a zip code. Initially, a local region may center around or start from a user-provided geo-specific information (also referred to herein as “user locale”). The local region may be refined, considering criteria such as distance, demographics, buying behaviors, etc. and leveraging data from the finest level of granularity available to the vehicle data system. For example, suppose a user is interested in two specific vehicle configurations: a BMW 3-series and a BMW 5-series, a vehicle data system may initially draw two local regions with identical or very similar demographics and buying behaviors. However, it could be that there are more BMW 3-series transactions than BMW 5-series transactions that are available to or accessible by the vehicle data system. In this case, the local region that is dynamically defined or selected for the BMW 3-series configuration may not need to be expanded or otherwise refined, while the local region that is dynamically defined or selected for the BMW 5-series configuration may need to expand to include additional “chunks” of geographic areas having similar demographics and buying behaviors such that the vehicle data system will have sufficient data for computing the vehicle pricing information. In one embodiment, such “chunks” of geographic areas may be within a single zip code. Various methods can be used to produce these geographical chunks. One example is provided below with reference to FIG. 8.

One approach involves using all the available information at the lowest level of granularity (e.g., zip code level data, DMA level data, etc.) to obtain parameter/attribute data such as distance information, demographic information, buying behavior information, etc. The parameters can be weighted utilizing a weighting function defined in Equation 1 below:

$${d}_{i , j} = {[ \begin{matrix}{β}_{1} \cdot {( \frac{{GCD}_{i , j}}{max\_dist} )}^{2} + \\ {{β}_{2} ( \frac{{temporal\_diff}_{i , j}}{max\_temp \_diff} )}^{2} + {\sum }_{p = 3}^{m} {{β}_{p} ( {v}_{i , p} - {v}_{j , p} )}^{2}\end{matrix} ]}^{1 / 2} \qquad [ Equation 1 ]$$

where GCD_{i,j} represents the Great Circle Distance between transaction i and transaction j for

$${v}_{j , p} = \frac{( {x}_{j , p -} {min}_{{i}_{d}} {x}_{. , p} )}{( {max}_{{i}_{d}} {x}_{. , p} - {min}_{{i}_{d}} {x}_{. , p} )}$$

$${v}_{i , p} = \frac{( {x}_{i , p -} {min}_{{i}_{d}} {x}_{. , p} )}{( {max}_{{i}_{d}} {x}_{. , p} - {min}_{{i}_{d}} {x}_{. , p} )}$$

where i represents the ith transaction, j represents the jth transaction, p represents the specific parameter/attribute of interest, and m represents the number of parameters/attributes. For distance and date, a threshold of comparison can serve as the maximum allowable value, for instance, 200 miles for distance and 28 days for transaction date. This threshold can be determined/assigned based on business/domain knowledge. Additionally,
i_{d}=the attribute of the dealer of the i^{th} transaction;
i_{c}=the attribute of the customer of the i^{th} transaction;
j_{d}=the attribute of the dealer of the i^{th} transaction;
j_{c}=the attribute of the customer of the i^{th} transaction.

So, for each transaction attribute, there exists a coupled pair (i,j) for comparison with other transactions. This can be detailed further for demographic and geographic attributes, in that each may have a specific version of the attribute for the customer and the dealer associated with that transaction.

As a specific example, suppose that “Transaction 1001” is to be compared with “Transaction 1023” as follows:

Transaction 1001: Year=2013, Make=Toyota, Model=Camry, customer zip code=90404, dealer zip code=90035, customer income=45000, dealer zip code average income=37000, date=Dec. 15, 2012
Transaction 1023: Year=2013, Make=Toyota, Model=Camry, customer zip code=90036, dealer zip code=90032, customer income=53000, dealer zip code average income=35500, date=Dec. 23, 2012

Also, suppose the distance between where the transactions occurred (between two dealer zip codes 90035 and 90032) is 12 miles. Leveraging the example maximum allowable threshold for distance (200 miles), a parameter in the weighting function can be determined as

$$( \frac{{GCD}_{i , j}}{max\_dist} ) = 0.06$$

For the purpose of illustration, further suppose that income and date characteristics are parameters/attributes that are also considered for the bin selection. For instance, if minⱼx_{.,p}=27000, maxⱼx_{.,p}=87000, then

$$[ {v}_{i , p} ( 45000 ) - {v}_{j , p} ( 53000 ) ] = [ \frac{( 45000 - {min}_{{i}_{d}} {x}_{. , p} )}{( {max}_{{i}_{d}} {x}_{. , p} - {min}_{{i}_{d}} {x}_{. , p} )} - \frac{( 53000 - {min}_{{i}_{d}} {x}_{. , p} )}{( {max}_{{i}_{d}} {x}_{. , p} - {min}_{{i}_{d}} {x}_{. , p} )} ] = - 0.1333 \\ [ {v}_{i , p} ( 37000 ) - {v}_{j , p} ( 35500 ) ] = [ \frac{( 37000 - {min}_{{i}_{d}} {x}_{. , p} )}{( {max}_{{i}_{d}} {x}_{. , p} - {min}_{{i}_{d}} {x}_{. , p} )} - \frac{( 35500 - {min}_{{i}_{d}} {x}_{. , p} )}{( {max}_{{i}_{d}} {x}_{. , p} - {min}_{{i}_{d}} {x}_{. , p} )} ] = 0.025$$

Similarly, the maximum and minimums at the thresholds of what is under consideration are assigned for the date function. In this case, a local model with a 4 week threshold can be built:

$$\frac{{temporal\_diff}_{i , j}}{max\_temp \_diff} = \frac{[ {x}_{i , date} - {x}_{j , date} ]}{28} = \frac{8}{28} = 0.286$$

Using Equation 1 above, each of the parameters/attributes under consideration is squared and multiplied by a chosen factor. Assuming the following factors: [1,0.6,0.4,0.4] were chosen, the weighting function can be computed as follows: d_{i,j}=[(1)·(0.06)²+0.6·(0.286)²+0.4·(−0.133)²+0.4·(0.025)²]^{1/2}=0.06

These weighting functions will be used in the definition of the local bins, q, as will be described in the sections to come. Furthermore, the methodology for assignment of the optimal weights will be described below after first putting into context a potential application.

Note that for both the computation of the customer and the dealer data, normalization based on the dealer data is used. This is to ensure the same indexing and to constrain the potentially large variations of the x variable that could occur if the denominator was set to the customer level. Note that a decision to include dealerfs information in the set to be presented can be made at the dealer j level (not the geographic boundary level).

Also, geographic boundaries can be leveraged at the lowest level of granularity needed. For instance, referring to FIG. 8, suppose a local region referred to as “ABC” represents the lowest level of granularity for which demographic data is available. As exemplified in FIG. 8, this local region can include a block of geographic areas, sub-blocks, or “chunks” (collectively referred to hereinafter as “sub-regions”) “A”, “B”, and “C”. Each of the sub-regions may represent the lowest level of granularity for which transaction data is available. As a specific example, suppose that within the sub-region “A,” there might be four different dealerships providing transactions information. As such, for a given customer i_{c} within the sub-region “A,” distances can be calculated to the lowest level of transactional granularity as that is the constraint on this example implementation. One way to compute the distance is to use the centroid of the geographic area (in this example, the centroid of the sub-region “A”).

Such a centroid can be a geographic centroid or a population-weighted centroid. A geographic centroid can be calculated as follows:

$${C}_{x} = \frac{\int {xS}_{y} ( x ) d x}{A} , {C}_{y} = \frac{\int {yS}_{x} ( y ) d y}{A} ;$$

translated to sub-regions would be:

$$( {x}_{c} , {y}_{c} ) = ( \frac{Σ {x}_{i}}{n} , \frac{Σ {y}_{i}}{n} ) .$$

In a population-weighted centroid of a geographic area, sub-level population data, pᵢ, exists for producing the desired weighting. As one of ordinary skill in the art can appreciate, in the case of sub-level population data (for instance, household information with population per household), one may use each household x coordinate, find the population weighted average within x and then do the same with the y coordinate such that

$$( {x}_{w} , {y}_{w} ) = ( \frac{Σ {p}_{i} {x}_{i}}{Σ {p}_{i}} , \frac{Σ {p}_{i} {y}_{i}}{Σ {p}_{i}} ) .$$

As another example, suppose that transactional data is available at the dealership level, behavioral information is available at the region level (the local region ABC), and demographic information is available at the sub-region level (the sub-region “A”). In this case, all of the information may be gathered at the lowest level of granularity. Then, the local region may be constructed as a collection of dealerships. For instance, an embodiment of a vehicle data system might be configured to show performance and market share of a given dealership relative to his local region of dealers. To do so, specific dealers may be selected to be in the particular local region (for the given dealership) based on the criteria mentioned in the equation above.

The weights described thus far can be heuristically assigned and fed into a kernel for localized binning. Leveraging the function to be supervised, an iterative approach can be taken to discern the appropriate weighting factors. For instance, a pricing model may be defined using a structure provided in the above-referenced U.S. patent application Ser. No. 13/173,357, filed Jun. 30, 2011, entitled “SYSTEM, METHOD AND COMPUTER PROGRAM PRODUCT FOR GEO-SPECIFIC VEHICLE PRICING,” which is fully incorporated by reference herein, such that

$$\frac{{price}_{i}}{{cost}_{i}} - {( \frac{\overline{{price}_{i}}}{{cost}_{i}} )}_{q} = {mr}_{i} - \overline{{mr}_{q}} = {α}_{0} + {α}_{m} + {\sum }_{j} {β}_{j} \cdot {x}_{i} + {\sum }_{k} {δ}_{k} \cdot {y}_{i} + {\sum }_{l} {λ}_{l} \cdot {z}_{i} + ρ {\sum }_{j \neq i} K ( {g}_{i , j} ) {ɛ}_{j} + {e}_{j} \qquad [ Equation 2 ]$$

where q is the local bin. Thus, note that the notational simplification

$${( \frac{\overline{{price}_{i}}}{{cost}_{i}} )}_{q}$$

refers to the average price to cost ratio for the transactions in the bin to which this particular observation belongs. Thus,

$${( \frac{\overline{{price}_{i}}}{{cost}_{i}} )}_{q} = \frac{{\sum }_{i = 1}^{{N}_{q}} ( \frac{\overline{{price}_{i}}}{{cost}_{i}} )}{{N}_{q}} .$$

The definition of the local bin, q, will be described in detail later.

In this case, the method might include heuristically choosing an α to be very high, relative to the β's. One reason is that more weight might be desired for a geographic distance attribute than on other attributes such as demographics or buying behaviors. Nevertheless, other attributes can be used to make a decision on which dealerships to include. For instance, due to differences in the geological terrain or infrastructure, perhaps a different demographic clientele (from a different geography), a first dealership may be selected as opposed to a second dealership, even though both are equally as far away from the given dealership.

The weights in the weighting function can be optimized in various ways. One example of weighting can be that all attributes are equally weighted. One example of weighting can be triangular shaped. Other weighting functions may also be possible. Further, weighting can be dynamically adapted to individual users as well as specific vehicles.

FIG. 9 depicts a flow diagram illustrating an example of a method for constructing a pricing model for providing user-centric, adaptive dynamic vehicle pricing. Method 900 may include
Definition of objective function (905)
Identification of constraints (910)
Extraction of relevant data (915)
Construction of key attributes (data and variable transformation) (920)
Optimization of model (925)

These steps will be further described in detail below. Note that method 900 may provide a final local region defined as two nearby, but geographically disconnected, regions. Given the objectives of the optimization as stated above, this result can be perfectly acceptable. If the user deemed that to not be an acceptable output, then further constraints could be imposed dynamically and in real time or substantially real time.

Definition of Objective Function (905)

Method 900 may begin with identifying a specific objective function that meets the purpose of the specific application on which a pricing model will be applied. For instance, if the objective or goal of the project is to create an accurate view of new car prices, then the objective function of the pricing model might be to minimize the least squares errors of predicted vs. actual historical prices such that

min[(Y−f(X))²].

Identification of Constraints and Refinement of Objective Function (910)

Method 900 may include additional constraints imposed on the objective function. For instance, the objective function of the pricing model to minimize the least squares errors of predicted vs. actual historical prices may include additional constraints such as a minimum size (# of transactions) for a valid subset, an equal number of transactions per overlapping geographic area, or a min/max temporal window, etc. At this step, these constraints can be identified for inclusion and the objective function modified accordingly such that min[(Y−f(X))] subject to constraints.

Extraction of Relevant Data (915)

Method 900 may include selecting the smallest area of data available for each source of information and ensuring that these subdivisions span the entire set of serviceable area of interest. For instance, if the US is the target area, then only partitions of the US are to be concerned.

Each specific data element (also referred to herein as “attribute” or “parameter”) may be extracted at its lowest level of granularity. However, the decision to display results need not be at the smallest geographic unit for which all classes of data are available. For instance, suppose that, in one embodiment, method 900 is configured for constructing a pricing model that considers three types of information: population density, income, and historical pricing averages (and hence the number of parameters/attributes m=3). Further, suppose that pricing averages were only available at the county level, but median income information was available at the five-digit zip code or “zip5” level of local regions (a five-digit zip code may be considered as a sub-region of a county, city, or DMA) and population density was obtainable at the zip5+4 level of local regions (a zip5+4 region may be considered as a sub-sub-region of a county, city, or DMA). Method 900 may include leveraging the most granular level of detail available for each such local region. Method 900 may further include compiling into any attribute the most granular details possible which, in this specific example, would be for the zip5+4 local regions. Accordingly, for each zip5+4 local region, the detailed unique population density values are used. Each zip5+4 local region would also have the median incomes and average sales prices; however, these values would be identical for all zip5+4 local regions within the same zip code for median income and within the same county for average sales.

Construction of Key Attributes (Data and Variable Transformation) (920)

Method 900 may include constructing a set of attributes by transforming historical data and variables using a weighting function as described above. As an example, as described above, attributes of interest can be constructed relative to the span of attributes in the dataset using a weighting function in the form of:

$${v}_{j , p} = \frac{( {x}_{j , p -} {min}_{{i}_{d}} {x}_{. , p} )}{( {max}_{{i}_{d}} {x}_{. , p} - {min}_{{i}_{d}} {x}_{. , p} )}$$

Optimization of Model (925)

The constructed attributes can then be used in a vehicle pricing model for realizing the stated objective function (min[(Y−f(X))] subject to constraints). Here, the optimization function:

$${Y}_{i} = \frac{{price}_{i}}{{cost}_{i}} - {( \frac{\overline{{price}_{i}}}{{cost}_{i}} )}_{q} = {mr}_{i} - \overline{{mr}_{q}} = {α}_{0} + {α}_{m} + {\sum }_{j} {γ}_{j} \cdot {x}_{i} + {\sum }_{k} {δ}_{k} \cdot {y}_{i} + {\sum }_{l} {λ}_{l} \cdot {z}_{i} + {ɛ}_{i}$$

is comprised of both a local component ( m̅r̅_̅{̅q̅}̅) designated by the location inclusion marker, q, and a global component αₒ+αₘ+Σⱼγⱼ·xᵢ+Σₖδₖ·yᵢ+Σᵢλᵢ·zᵢ+εᵢ. The determination of the local component, q, may proceed as follows.

Step 1: A bin, q, is defined both in type of vehicle (year-make-model) as well as locality using heuristic weights, as defined in Equation 1. For step 1, a kernel function may be selected for assigning inclusion into the local bin. In one embodiment, multiple kernel functions may be selected. If multiple kernel functions are chosen for assigning inclusion into a local bin, the next two steps may be iteratively looped through for each potential kernel function chosen. As a specific example, presume that a step function kernel function below is selected for assigning inclusion into a local bin:

$${D}_{ij , r} = \{ \begin{matrix}1 & if {d}_{i , j} \leq r \\ 0 & if {d}_{i , j} > r\end{matrix} \qquad [ Equation 3 ]$$

This thresholding function, D_{ij,r}, can serve to identify a ‘distance’ threshold for inclusion into a local bin. For instance, presume that r is set to 0.1 (by an administrator or practitioner implementing an embodiment disclosed herein). In the earlier example described above, d_{i,j}=0.06. In this example, d_{i,j}≦r. Accordingly, D_{ij,r}=1. In this case, observations with D_{ij,r}=1 will be included in the set q, whereas those observations with D_{ij,r}=0 will not.

With that computation, the local region q can be set for the transaction, i. Accordingly, an appropriate pricing model can now be constructed to minimize (or maximize) the objective function.

Step 2: Starting with an initial set of weights for βₚ in the weighting function for determination of q, the rest of the weights can be solved in closed form using a method, such as the ordinary least square (OLS) method to determine the optimal global parameters. The OLS and other suitable methods are known to those skilled in the art and thus are not further described herein.

Step 3: From here, iterations can be applied to the starting values of the heuristic localized weights to hone in on a more optimized solution (the specific optimization of the local parameters). Different methods are available here, including gradient descent methods (which move in the direction of lowest errors), more randomized methods like Genetic Algorithms, and even fully defined discretized lists. For example, an array of possible weights may be created for each attribute (or values ∀βₚ) in Equation 1 as follows: βₚε[0 0.2 0.4 0.6 0.8 1.0]

Leveraging the set of possible weights for the parameters βₚ for each attribute (in Equation 1), the best model can be evaluated for each of the possible localization metrics, for a total of 6^{(m+1)} combinations (since, in this case, 6 is the length of the array of possible weights) and choose the best. As m gets large and pending on the computing power of a practitioner's machine, he may choose to employ a method that will more quickly converge on a high quality locally optimal solution. Suitable methods may include, but are not limited to, gradient descent, Levenberg-Marquardt, genetic algorithm, etc.

Following the above example, for the choice of r=0.1, one may iterate over all possible combinations of values for βₚ, creating a separate pricing model for each possible combination and then choosing the optimal weighting and kernel factors (based on minimal squared errors). After fitting each of those pricing models, the best pricing model is chosen. For this example, where m=3, 6⁴ pricing models were created and the best one was selected using a cross-validation sample—the final, chosen pricing model has the best performance characteristics and the lowest adjusted R² on the validation sample. Note that if one were using a gradient descent methodology, this iterative refinement procedure would be inherently built into the algorithm.

At this point, a pricing model has been constructed for future observations. Below provides an example illustrating how a pricing model thus constructed can provide for user-centric, adaptive dynamic vehicle pricing based at least in part on variable market areas.

An embodiment of a vehicle data system may receive a new observation from a user via a web site on the Internet. Suppose that the new observation is for a 2013 Toyota Camry in the zip code of 90403, the vehicle data system may construct each of the variables (as exemplified above using Equation 1) and compare the attributes of this new observation with every other 2013 Toyota Camry transaction in the past 4 weeks and within the pre-determined 200 mile radius of the 90403 zip code. Using the weights for βₚ that have been optimized by the model described above, the vehicle data system may construct d_{i,j} and ultimately D_{ij,r} for each of the relevant 2013 Toyota Camry observations in the dataset. This produces a set of observations that are within the local region of the user. To generate the average price that the user can expect to pay for the 2013 Toyota Camry that he selected, the vehicle data system may plug in the values for Yᵢ=mrᵢ− m̅r̅_̅{̅q̅}̅=αₒ+αₘ+Σⱼγⱼ·xᵢ+Σₖδₖ·yᵢ+Σₗλₗ·zᵢ+εᵢ.

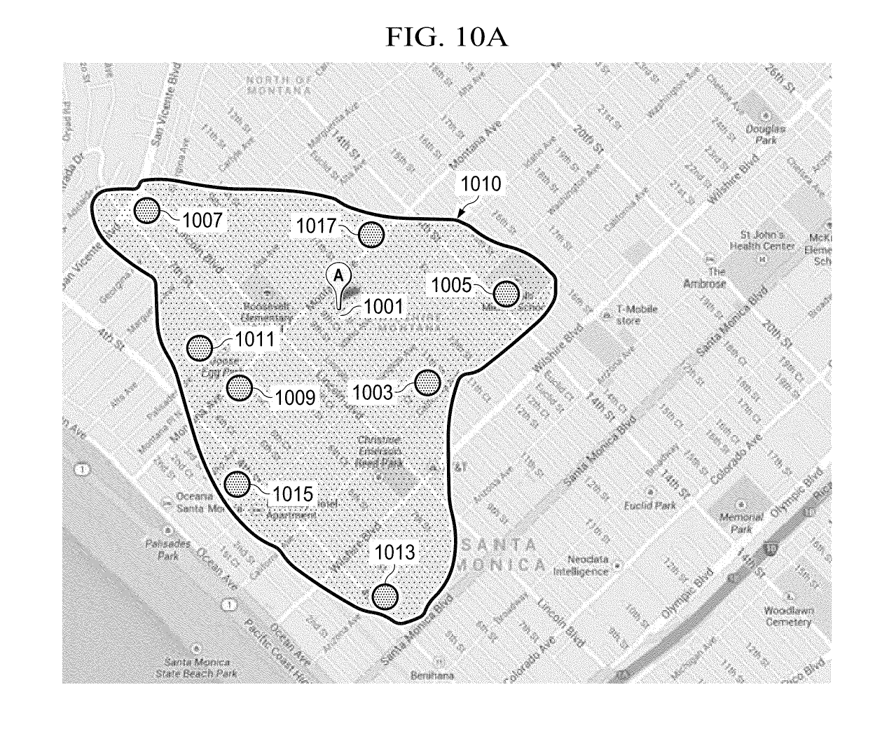

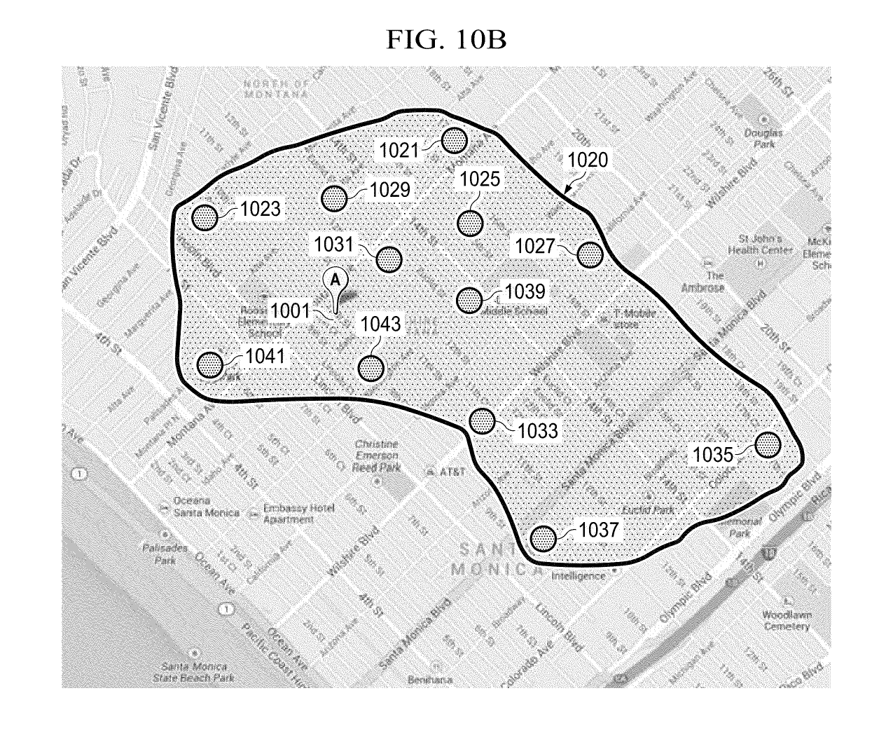

In one embodiment, the vehicle data system may be configured to display spatially the observations that were selected for inclusion. FIGS. 10A-10B depict diagrammatic representations of possible local regions (variable market areas) that may be dynamically determined for a user in response to the user requesting pricing information on a particular vehicle configuration (a new observation). Note that in FIGS. 10A-10B, the user's location is known by an actual address represented by point 1010. If, however, the user's location was not specified down to this level of granularity, the vehicle data system can still proceed with the same computations as described above.

In the example of FIG. 10A, various locations 1003, 1005, 1007, 1009, 1011, 1013, 1015, and 1017 of past similar transactions are used to construct the local region for the new observation submitted by the user. As FIG. 10A illustrates, the observations (at locations 1003, 1005, 1007, 1009, 1011, 1013, 1015, and 1017) selected for inclusion may be displayed and represented by a scatterplot of dots, rather than a polygon. In one embodiment and as a non-limiting example, the vehicle data system may be configured to optionally draw shape 1010 outlining the expanse of those dots representing the dynamic local region thus generated for the user requesting pricing information on the new observation (of a specific vehicle configuration).

As another example, suppose that the same user has submitted another price report request for a 2013 Chevy Impala in the same zip code 90403. In this case, the vehicle data system may proceed as described above to construct the local set of observations (represented by dots 1021, 1023, 1025, 1027, 1029, 1031, 1033, 1035, 1037, 1039, 1041, and 1043) to use for bin, q, as well as the final computation of price. However, as illustrated in FIG. 10B, based on availability of transactions and differences in customer income levels, dynamic (user-centric) local region 1010 (FIG. 10A) and dynamic (user-centric) local region 1020 (FIG. 10B) can be quite different based on the specific product (vehicle) being investigated by the vehicle data system, even for the same user and the same locale.

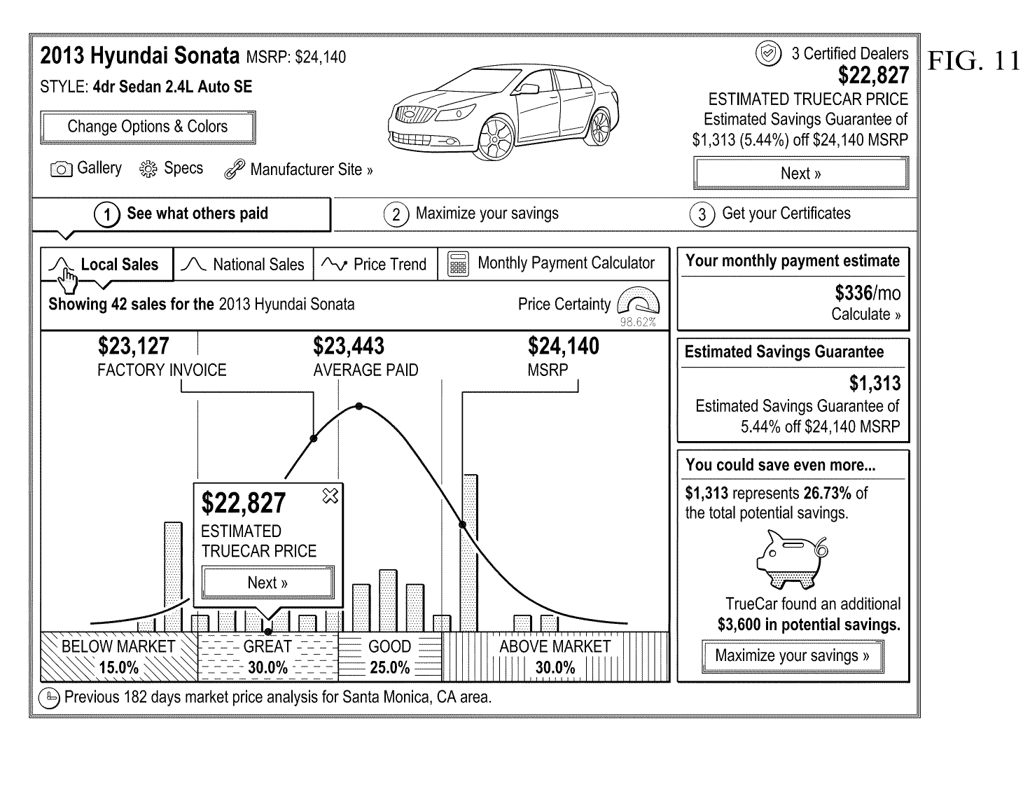

In some embodiments, different market areas and/or local regions may be dynamically generated and/or selected and presented to a user as different layers superimposed on a map, with pricing information specific to each layer. As exemplified above, since the distribution of parameter data could be vastly different for different products, the dynamically defined market areas can have vastly different shapes and/or sizes. Other visualizations may also be possible. For example, for the purpose of illustration and not of limitation, FIG. 11 depicts a diagrammatic representation of a screenshot of an example user interface showing local level pricing information on a user-specified vehicle with trim-level specificity. In this example, sales data for that local region are presented over a bell curve. Additionally, various matrices such as gross margins for other dealers in the same local region may be displayed.

Although the invention has been described with respect to specific embodiments thereof, these embodiments are merely illustrative, and not restrictive of the invention. The description herein of illustrated embodiments of the invention, including the description in the Abstract and Summary, is not intended to be exhaustive or to limit the invention to the precise forms disclosed herein (and in particular, the inclusion of any particular embodiment, feature or function within the Abstract or Summary is not intended to limit the scope of the invention to such embodiment, feature or function). Rather, the description is intended to describe illustrative embodiments, features and functions in order to provide a person of ordinary skill in the art context to understand the invention without limiting the invention to any particularly described embodiment, feature or function, including any such embodiment feature or function described in the Abstract or Summary. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Reference throughout this specification to “one embodiment”, “an embodiment”, or “a specific embodiment” or similar terminology means that a particular feature, structure, or characteristic described in connection with the embodiment is included in at least one embodiment and may not necessarily be present in all embodiments. Thus, respective appearances of the phrases “in one embodiment”, “in an embodiment”, or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Embodiments discussed herein can be implemented in a computer communicatively coupled to a network (for example, the Internet), another computer, or in a standalone computer. As is known to those skilled in the art, a suitable computer can include a central processing unit (“CPU”), at least one read-only memory (“ROM”), at least one random access memory (“RAM”), at least one hard drive (“HD”), and one or more input/output (“I/O”) device(s). The I/O devices can include a keyboard, monitor, printer, electronic pointing device (for example, mouse, trackball, stylist, touch pad, etc.), or the like.

ROM, RAM, and HD are computer memories for storing computer-executable instructions executable by the CPU or capable of being complied or interpreted to be executable by the CPU. Suitable computer-executable instructions may reside on a computer readable medium (e.g., ROM, RAM, and/or HD), hardware circuitry or the like, or any combination thereof. Within this disclosure, the term “computer readable medium” or is not limited to ROM, RAM, and HD and can include any type of data storage medium that can be read by a processor. For example, a computer-readable medium may refer to a data cartridge, a data backup magnetic tape, a floppy diskette, a flash memory drive, an optical data storage drive, a CD-ROM, ROM, RAM, HD, or the like. The processes described herein may be implemented in suitable computer-executable instructions that may reside on a computer readable medium (for example, a disk, CD-ROM, a memory, etc.). Alternatively, the computer-executable instructions may be stored as software code components on a direct access storage device array, magnetic tape, floppy diskette, optical storage device, or other appropriate computer-readable medium or storage device.

Any suitable programming language can be used, individually or in conjunction with another programming language, to implement the routines, methods or programs of embodiments of the invention described herein, including C, C++, Java, JavaScript, HTML, or any other programming or scripting language, etc. Other software/hardware/network architectures may be used. For example, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It is also within the spirit and scope of the invention to implement in software programming or code an of the steps, operations, methods, routines or portions thereof described herein, where such software programming or code can be stored in a computer-readable medium and can be operated on by a processor to permit a computer to perform any of the steps, operations, methods, routines or portions thereof described herein. The invention may be implemented by using software programming or code in one or more general purpose digital computers, by using application specific integrated circuits, programmable logic devices, field programmable gate arrays, optical, chemical, biological, quantum or nanoengineered systems, components and mechanisms may be used. In general, the functions of the invention can be achieved by any means as is known in the art. For example, distributed, or networked systems, components and circuits can be used. In another example, communication or transfer (or otherwise moving from one place to another) of data may be wired, wireless, or by any other means.

A “computer-readable medium” may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory. Such computer-readable medium shall generally be machine readable and include software programming or code that can be human readable (e.g., source code) or machine readable (e.g., object code). Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices. In an illustrative embodiment, some or all of the software components may reside on a single server computer or on any combination of separate server computers. As one skilled in the art can appreciate, a computer program product implementing an embodiment disclosed herein may comprise one or more non-transitory computer readable media storing computer instructions translatable by one or more processors in a computing environment.

A “processor” includes any hardware system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Portions of processing can be performed at different times and at different locations, by different (or the same) processing systems.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, including the claims that follow, a term preceded by “a” or “an” (and “the” when antecedent basis is “a” or “an”) includes both singular and plural of such term, unless clearly indicated within the claim otherwise (i.e., that the reference “a” or “an” clearly indicates only the singular or only the plural). Also, as used in the description herein and throughout the claims that follow, the meaning of “in” includes “in” and “on” unless the context clearly dictates otherwise. The scope of the present disclosure should be determined by the following claims and their legal equivalents.

What is claimed is:

1. A method for providing local pricing information on a user-specified vehicle configuration, comprising:
receiving, via a network site by a vehicle data system having a processor and a memory, a request from a user for pricing information on the user-specified vehicle configuration, the request including geo-specific information identifying a user locale;
dynamically computing, by the vehicle data system in a frontend process, a local region for the user-specified vehicle configuration and the user locale based at least in part on actual historical transactions that are similar to the user-specified vehicle configuration, the user, the user locale, or a combination thereof;
determining the local pricing information for the user-specified vehicle configuration in the dynamically computed local region; and
presenting the local pricing information for the user-specified vehicle configuration to the user via the network site in response to the request from the user.

2. The method according to claim 1, further comprising:
extracting, from historical data by the vehicle data system, data for a number of attributes of interest in the user locale at a lowest level of granularity for which transaction data is available for each attribute of the number of attributes of interest.

3. The method according to claim 2, further comprising:
constructing, by the vehicle data system, the number of attributes of interest relative to attributes in the historical data using a weighting function.

4. The method according to claim 3, further comprising:
constructing, by the vehicle data system, a pricing model having a local component and a global component.

5. The method according to claim 4, further comprising:
for each attribute of the number of attributes, determining a locally optimal solution.

6. The method according to claim 4, wherein the local component is defined at least in part by a localized binning of historical observations.

7. The method according to claim 1, wherein the number of attributes of interest comprises at least one of transaction attributes, demographic attributes, or geographic attributes.

8. A system, comprising:
a processor; and
a memory storing instructions executable by the processor to perform:
receiving, via a network site, a request from a user for pricing information on a user-specified vehicle configuration, the request including geo-specific information identifying a user locale;
dynamically computing, in a frontend process, a local region for the user-specified vehicle configuration and the user locale based at least in part on actual historical transactions that are similar to the user-specified vehicle configuration, the user, the user locale, or a combination thereof;
determining the local pricing information for the user-specified vehicle configuration in the dynamically computed local region; and
presenting the local pricing information for the user-specified vehicle configuration to the user via the network site in response to the request from the user.

9. The system of claim 8, wherein the instructions are further executable by the processor to perform:
extracting, from historical data, data for a number of attributes of interest in the user locale at a lowest level of granularity for which transaction data is available for each attribute of the number of attributes of interest.

10. The system of claim 9, wherein the instructions are further executable by the processor to perform:
constructing the number of attributes of interest relative to attributes in the historical data using a weighting function.

11. The system of claim 10, wherein the instructions are further executable by the processor to perform:
constructing a pricing model having a local component and a global component.

12. The system of claim 11, wherein the instructions are further executable by the processor to perform:
for each attribute of the number of attributes, determining a locally optimal solution.

13. The system of claim 11, wherein the local component is defined at least in part by a localized binning of historical observations.

14. The system of claim 11, wherein the number of attributes of interest comprises at least one of transaction attributes, demographic attributes, or geographic attributes.

15. A computer program product for providing local pricing information on a user-specified vehicle configuration, the computer program product comprising at least one non-transitory computer readable medium storing instructions executable by a processor to perform:
receiving, via a network site, a request from a user for pricing information on the user-specified vehicle configuration, the request including geo-specific information identifying a user locale;
dynamically computing, in a frontend process, a local region for the user-specified vehicle configuration and the user locale based at least in part on actual historical transactions that are similar to the user-specified vehicle configuration, the user, the user locale, or a combination thereof;
determining the local pricing information for the user-specified vehicle configuration in the dynamically computed local region; and
presenting the local pricing information for the user-specified vehicle configuration to the user via the network site in response to the request from the user.

16. The computer program product of claim 15, wherein the instructions are further executable by the processor to perform:
extracting, from historical data, data for a number of attributes of interest in the user locale at a lowest level of granularity for which transaction data is available for each attribute of the number of attributes of interest.

17. The computer program product of claim 16, wherein the instructions are further executable by the processor to perform:
constructing the number of attributes of interest relative to attributes in the historical data using a weighting function.

18. The computer program product of claim 17, wherein the instructions are further executable by the processor to perform:
constructing a pricing model having a local component and a global component.

19. The computer program product of claim 18, wherein the instructions are further executable by the processor to perform:
for each attribute of the number of attributes, determining a locally optimal solution.

20. The computer program product of claim 18, wherein the local component is defined at least in part by a localized binning of historical observations.
